(19) United States
(12) Patent Application Publication
(10) Pub. No.: US 2026/0236483 A1
(43) Pub. Date: Aug. 13, 2026

(54) DATA ANALYSIS METHOD, APPARATUS, DEVICE, MEDIUM, AND PRODUCT BASED ON MULTI-ROUND QUESTION ANSWERING

(71) Applicant: Beijing Volcano Engine Technology Co., Ltd., Beijing (CN)

(72) Inventor: Shufang CAO, Beijing (CN)

(21) Appl. No.: 19/532,960

(22) Filed: Feb. 6, 2026

(30) Foreign Application Priority Data
Feb. 8, 2025 (CN) 202510142496.4

(51) Int. Cl. G06F 16/248; G06F 3/0482; G06F 16/9032

(52) U.S. Cl. CPC G06F 16/248; G06F 3/0482; G06F 16/90332

(57) ABSTRACT

A data analysis method and apparatus based on multi-round question answering, a device, a medium, and a product relate to the fields of data processing technologies, artificial intelligence technologies, large model technologies, and large language model technologies. The data analysis method includes: displaying a data analysis page, where the data analysis page includes a dialogue area, at least one first question answering pair is displayed in the dialogue area, the first question answering pair has a corresponding group label, a first sub-area of the dialogue area is used for displaying the group label, and the group label is determined based on a semantic analysis result of the first question answering pair; and determining a first group label in response to a selection instruction for the group label in the first sub-area, and displaying, in the dialogue area, a first question answering pair corresponding to the first group label.

### CROSS-REFERENCE TO RELATED APPLICATION(S)

The present application claims priority to Chinese Patent Application No. 202510142496.4, filed with the China National Intellectual Property Administration on February 8, 2025 and entitled "DATA ANALYSIS METHOD, APPARATUS, DEVICE, MEDIUM, AND PRODUCT BASED ON MULTI-ROUND QUESTION ANSWERING ", which is incorporated herein by reference in its entirety.

### FIELD

The present disclosure relates to the field of data processing technologies, artificial intelligence technologies, large model technologies, and large language model technologies, and in particular, to a data analysis method and apparatus based on multi-round question answering, a device, a medium, and a product.

### BACKGROUND

At present, mainstream data analysis applications mainly use language models to answer users' questions. In a dialogue process, a user may continuously diverge questions or continuously drill down questions for the same question.

### SUMMARY

The present disclosure provides a data analysis method and apparatus based on multi-round question answering, an electronic device, a storage medium, and a program product.

According to a first aspect, the present disclosure provides a data analysis method based on multi-round question answering. The method includes:

displaying a data analysis page, where the data analysis page includes a dialogue area, at least one first question answering pair is displayed in the dialogue area, the first question answering pair has a corresponding group label, a first sub-area of the dialogue area is used for displaying the group label, and the group label is determined based on a semantic analysis result of the first question answering pair; and

determining a first group label in response to a selection instruction for the group label in the first sub-area, and displaying, in the dialogue area, a first question answering pair corresponding to the first group label.

According to a second aspect, the present disclosure provides a data analysis apparatus based on multi-round question answering. The apparatus includes:

a first display module, configured to display a data analysis page, where the data analysis page includes a dialogue area, at least one first question answering pair is displayed in the dialogue area, the first question answering pair has a corresponding group label, a first sub-area of the dialogue area is used for displaying the group label, and the group label is determined based on a semantic analysis result of the first question answering pair; and

a second display module, configured to determine a first group label in response to a selection instruction for the group label in the first sub-area, and display, in the dialogue area, a first question answering pair corresponding to the first group label.

According to a third aspect, the present disclosure provides an electronic device. The electronic device includes a memory and a processor. The memory is communicatively connected to the processor. The memory stores computer instructions. The processor executes the computer instructions to perform the data analysis method based on multi-round question answering according to the first aspect or any one of the corresponding implementations.

According to a fourth aspect, the present disclosure provides a computer-readable storage medium. The computer-readable storage medium stores computer instructions. The computer instructions are used to enable a computer to perform the data analysis method based on multi-round question answering according to the first aspect or any one of the corresponding implementations.

According to a fifth aspect, the present disclosure provides a computer program product, including computer instructions. The computer instructions are used to enable a computer to perform the data analysis method based on multi-round question answering according to the first aspect or any one of the corresponding implementations.

The beneficial effects of the data analysis apparatus based on multi-round question answering, the electronic device, the storage medium, and the program product correspond to the beneficial effects of the data analysis method based on multi-round question answering, and details are not described herein again.

### BRIEF DESCRIPTION OF THE DRAWINGS

To describe the technical solutions in the specific implementations of the present disclosure or in the prior art more clearly, the following briefly introduces the drawings required

for describing the specific implementations or the prior art. Apparently, the drawings in the following description show some implementations of the present disclosure, and other drawings may also be obtained by a person of ordinary skill in the art according to these drawings without creative efforts.

FIG. 1 is a schematic flowchart of a data analysis method based on multi-round question answering according to an embodiment of the present disclosure;

FIG. 2 is a schematic diagram of an initial page according to an embodiment of the present disclosure;

FIG. 3 is a schematic diagram of a first dialogue area according to an embodiment of the present disclosure;

FIG. 4 is a schematic diagram of a first sub-area according to an embodiment of the present disclosure;

FIG. 5 is a schematic diagram of a second dialogue area according to an embodiment of the present disclosure;

FIG. 6 is a schematic diagram of displaying description information and the number of question answering pairs according to an embodiment of the present disclosure;

FIG. 7 is a schematic diagram of an attribute page according to an embodiment of the present disclosure;

FIG. 8 is a schematic diagram of a third dialogue area according to an embodiment of the present disclosure;

FIG. 9 is a schematic diagram of a fourth dialogue area according to an embodiment of the present disclosure;

FIG. 10 is a schematic diagram of a drawing board area according to an embodiment of the present disclosure;

FIG. 11 is a schematic diagram of another drawing board area according to an embodiment of the present disclosure;

FIG. 12 is a schematic diagram of historical analysis content and a title thereof according to an embodiment of the present disclosure;

FIG. 13 is a block diagram of a data analysis apparatus based on multi-round question answering according to an embodiment of the present disclosure; and

FIG. 14 is a block diagram of an electronic device according to an embodiment of the present disclosure.

### DETAILED DESCRIPTION OF EMBODIMENTS

To make the objectives, technical solutions, and advantages of the embodiments of the present disclosure clearer, the technical solutions in the embodiments of the present disclosure are described clearly and completely below with reference to the drawings in the embodiments of the present disclosure. Apparently, the described embodiments are some but not all of the embodiments of the present disclosure. All other embodiments obtained by a person of ordinary skill in the art based on the embodiments of the present disclosure without creative efforts shall fall within the scope of protection of the present disclosure.

It may be understood that before the use of the technical solutions disclosed in the embodiments of the present disclosure, users shall be informed of the type, range of use, use scenarios etc. of personal information involved in the present disclosure in an appropriate manner and the authorization of the users shall be obtained in accordance with relevant laws and regulations.

For example, in response to reception of an active request from a user, prompt information is sent to the user to clearly inform the user that the requested operation will require access to and use of personal information of the user. As such, the user may independently choose, based on the prompt information, whether to provide the personal information to software or hardware, such as an electronic device, an application, a server, or a storage medium, that performs the operations of the technical solutions of the present disclosure.

As an optional but non-limiting implementation, in response to the reception of the active request from the user, the prompt information may be sent to the user in the form of, for example, a pop-up window, in which the prompt information may be presented in text. Furthermore, the pop-up window may also include a selection control for the user to choose whether to "agree" or "disagree" to provide the personal information to the electronic device.

It may be understood that the above process of notifying the user and obtaining the authorization of the user is only illustrative and does not limit the implementations of the present disclosure, and other manners that satisfy the relevant laws and regulations may also be applied in the implementations of the present disclosure.

It may be understood that the data involved in the technical solutions (including but not limited to the data itself, acquisition or use of the data) shall comply with the requirements of the corresponding laws, regulations, and related provisions.

At present, mainstream data analysis applications mainly use language models to answer users' questions. In a dialogue process, a user may continuously diverge questions or continuously drill down questions for the same question. After a multi-round dialogue, a longitudinal dialogue flow becomes very long, and if the user wants to locate historical content, the user needs to scroll up the page to continuously search for the required content, and the efficiency of querying the historical content is low.

In addition, when the user uses the content of an answer from a language model to perform analysis, the user needs to copy the content of the answer. Then, the copied content is pasted into a document of a third-party tool for analysis, which leads to a long analysis path. Moreover, during the analysis process, the third-party tool needs to be used alternately.

In view of this, according to an embodiment of the present disclosure, an embodiment of a data analysis method based on multi-round question answering is provided. And one or more embodiments of the present disclosure may solve the problem of low efficiency of querying historical content in data analysis applications. It should be noted that the steps shown in the flowcharts of the drawings may be executed in a computer system, such as a set of computer-executable instructions. Moreover, although a logical sequence is shown in the flowchart, in some cases, the steps shown or described may be executed in an order different from that here.

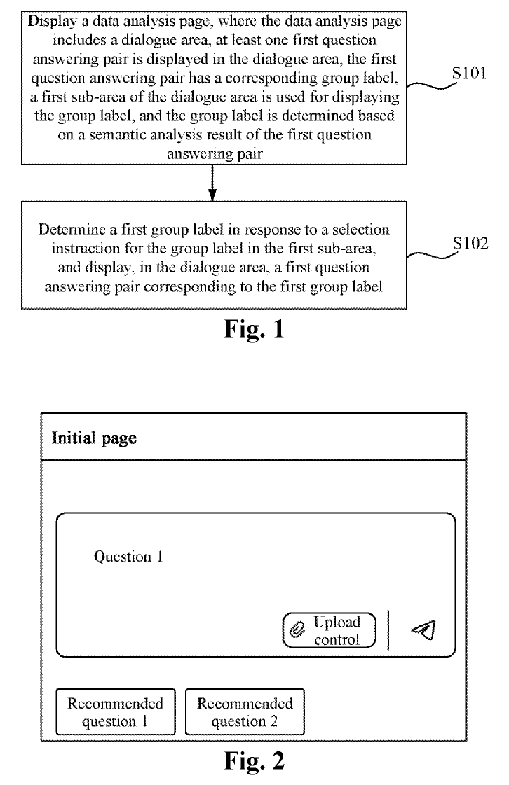

In this embodiment, a data analysis method based on multi-round question answering is provided, which may be used for data analysis applications. FIG. 1 is a schematic flowchart of a data analysis method based on multi-round question answering according to an embodiment of the present disclosure. As shown in FIG. 1, the process includes the following steps.

Step S101: a data analysis page is displayed, where the data analysis page includes a dialogue area, at least one first question answering pair is displayed in the dialogue area, the first question answering pair has a corresponding group label, a first sub-area of the dialogue area is used for displaying the group label, and the group label is determined based on a semantic analysis result of the first question answering pair.

The first question answering pair includes a question and answer content of the question.

Optionally, the 1st first question answering pair may be obtained through the following steps: displaying an initial page; and in response to determining a first question on the initial page, displaying the data analysis page, and displaying the 1st first question answering pair in the dialogue area of the data analysis page, where the 1st first question answering pair includes the first question determined on the initial page and answer content of the first question. The first question may be determined in response to a question input in an input control on the initial page. Alternatively, one or more recommended questions are displayed on the initial page, and the first question is determined in response to a selection instruction for the recommended questions.

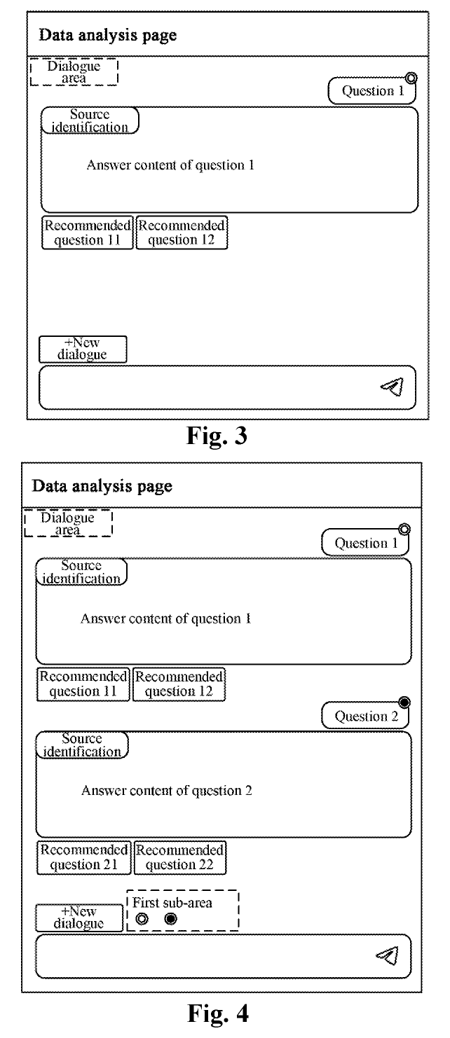

Exemplarily, as shown in FIG. 2, a user may input Question 1 in the input control on the initial page, or select one recommended question from Recommended Question 1 and Recommended Question 2 displayed on the initial page as the first question. In response to the first question determined on the initial page, the data analysis application displays the data analysis page and displays the 1st first question answering pair in the dialogue area of the data analysis page, such as Question 1 and the answer content of Question 1 shown in FIG. 3.

In addition, when the first question is determined using the initial page, an upload control is further displayed on the initial page, and the upload control is used for uploading a target file as a data source for data analysis. The data analysis may be performed on the first question through the target file to obtain the answer content of the first question.

In another optional implementation, the 1st first question answering pair may also be obtained through the following steps: in response to determining a first question in the dialogue area, displaying the 1st first question answering pair in the dialogue area, where the 1st first question answering pair includes the first question and answer content of the first question. The first question may be determined in response to a question input in an input control in the dialogue area. Alternatively, one or more recommended questions are displayed in the dialogue area, and the first question is determined in response to a selection instruction for the recommended questions.

The other first question answering pairs are obtained through the following steps: in response to determining a next question in the dialogue area, displaying a next first question answering pair in the dialogue area, where the next first question answering pair includes the next question and answer content of the next question. The next question may be determined in response to a question input in an input control in the dialogue area. Alternatively, a corresponding recommended question is displayed in an area corresponding to each first question answering pair in the dialogue area, and the next question is determined in response to a selection instruction for the recommended question.

It should be noted that the dialogue area has a corresponding first language model. Each question is analyzed using the first language model to obtain the answer content of the question, to obtain the first question answering pair.

In addition, the first language model may also be used to perform semantic analysis on each first question answering pair to obtain the semantic analysis result of the first question answering pair. The group label of each first question answering pair is determined based on the semantic analysis result of the first question answering pair.

Specifically, the first language model performs semantic analysis on the first question answering pair based on the question and contextual information in each first question answering pair, to obtain the semantic analysis result of each first question answering pair.

Exemplarily, as shown in FIG. 4, FIG. 4 shows two first question answering pairs. One first question answering pair includes Question 1 and the answer content of Question 1. The other first question answering pair includes Question 2 and the answer content of Question 2. The group labels corresponding to the two first question answering pairs are displayed in the first sub-area in the dialogue area.

Optionally, in actual applications, to quickly locate an initial question (that is, the first question), the group label of the 1st first question answering pair is different from those of other question answering pairs.

Step S102: a first group label is determined in response to a selection instruction for the group label in the first sub-area, and a first question answering pair corresponding to the first group label is displayed in the dialogue area.

In actual applications, if a non-text group label is used, when an interaction point is located at a position corresponding to the group label, description information of the group label may be displayed, to help a user determine, based on the description information, the group label of the first question answering pair to be searched for.

The first question answering pair corresponding to the first group label displayed in the dialogue area is not limited to a current dialogue round, the first question answering pair corresponding to the first group label may be displayed across rounds, and the dialogue may be continued under the first question answering pair corresponding to the first group label. After global display is restored (that is, the first group label is deselected), the dialogue rounds are still displayed in the order of question answering time.

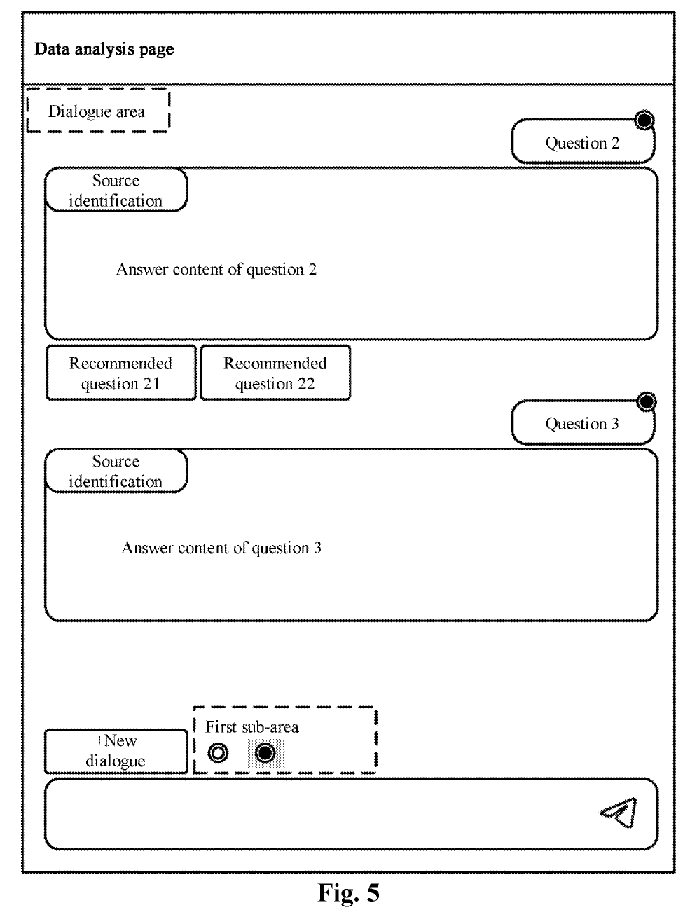

Exemplarily, as shown in FIG. 5, it is assumed that the second group label in the first sub-area shown in FIG. 5 corresponds to two first question answering pairs, for example, a first question answering pair composed of Question 2 and the answer content of Question 2 and a first question answering pair composed of Question 3 and the answer content of Question 3. In this case, when the second group label in the first sub-area is selected, the first question answering pairs corresponding to Question 2 and Question 3 are displayed.

According to the data analysis method based on multi-round question answering provided in this embodiment, each first question answering pair is configured with a corresponding group label. While the first question answering pair is displayed in the dialogue area of the data analysis page, the group label of the first question answering pair is further displayed in the first sub-area of the dialogue area. Therefore, the user only needs to select, in the first sub-area, the group label corresponding to the historical dialogue content that needs to be searched for, to display, in the dialogue area, the first question answering pair corresponding to the group label, to quickly search for the required historical dialogue content from the first question answering pair, thereby improving the efficiency of searching for the historical dialogue content.

In some optional implementations, the data analysis method based on multi-round question answering according to the present disclosure further includes: if a current interaction point is located at a position corresponding to any group label in the first sub-area, displaying the number of question answering pairs corresponding to the group label and description information of the group label.

The description information includes a dialogue topic represented by the group label, and the dialogue topic is related to a question of a first question answering pair under the group label.

Optionally, the dialogue topic of the group label is determined based on a semantic analysis result of the first question answering pair under the group label. Specifically, the first language model is used to perform topic analysis on the first question answering pair under the group label to obtain the dialogue topic corresponding to the group label.

It may be understood that when question answering pairs are continuously added subsequently, a new group label may be generated. If the question answering pairs under the group label include the first question answering pair, the dialogue topic corresponding to the group label is related to a question of the 1st first question answering pair under the group label. If the question answering pairs under the group label only include question answering pairs (such as the second question answering pair) added subsequently, the dialogue topic corresponding to the group label is related to a question of a first question answering pair added under the group label.

In addition, the user may also customize the description information of the group label, and a manner of generating the description information is not limited herein.

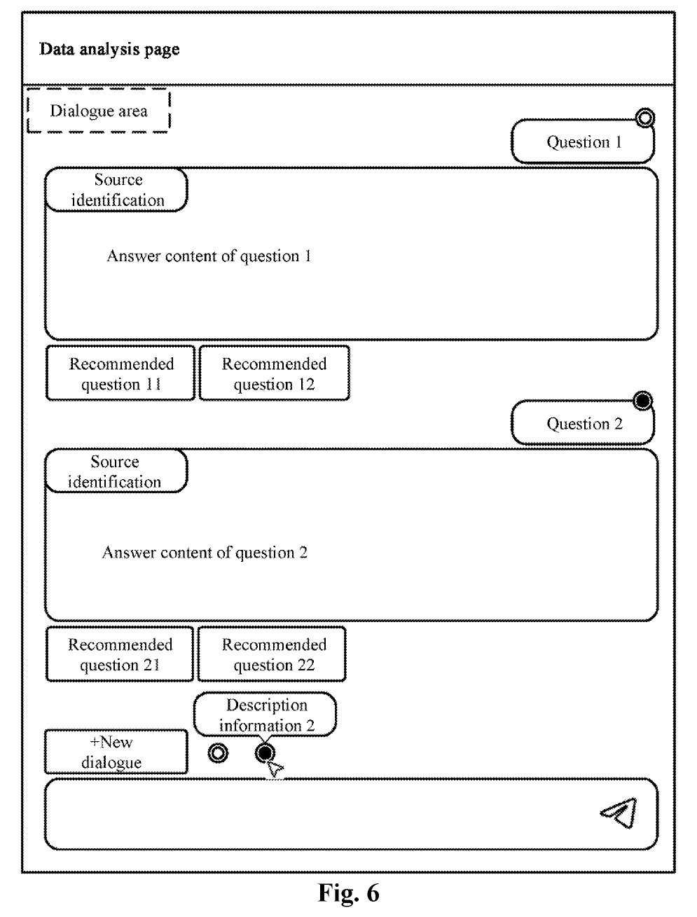

Exemplarily, as shown in FIG. 6, when the current interaction point is located at a position corresponding to the second group label in the first sub-area, the description information corresponding to the second group label and the number of question answering pairs (see 2 shown in FIG. 6) are displayed.

According to the data analysis method based on multi-round question answering provided in this embodiment, when the current interaction point is located at the position corresponding to any group label in the first sub-area, the number of question answering pairs corresponding to the group label and the description information of the group label are displayed. Therefore, the group label of the historical dialogue content to be searched for may be quickly located.

In some optional implementations, the group label is displayed in a second sub-area corresponding to each first question answering pair in the dialogue area. The data analysis method based on multi-round question answering according to the present disclosure further includes the following steps.

Step a1: an attribute page of the group label is displayed in response to an interaction operation on the group label in any second sub-area, where the attribute page is used for configuring a display attribute of the group label.

The second sub-area corresponding to the first question answering pair is a corresponding area of the question in the first question answering pair, for example, an upper right area of the question in the first question answering pair.

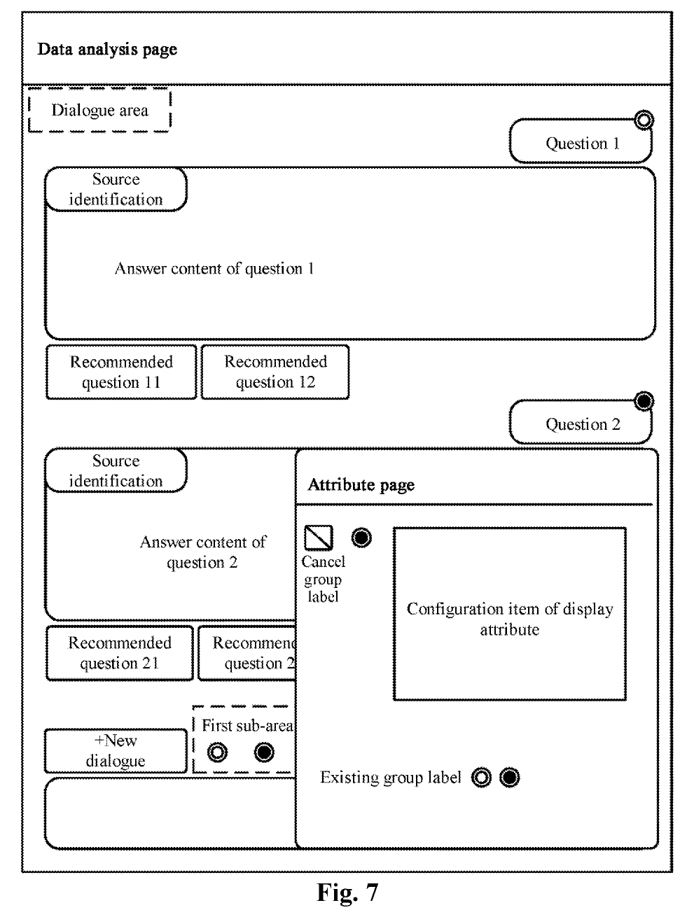

Referring to FIG. 7, the attribute page includes a configuration item of the display attribute of the group label, and the display attribute of the group label is determined in response to a configuration operation on the configuration item. The display attribute includes at least one of existence, color, or shape of the group label, and the display attribute may be adjusted based on the actual situation.

In addition, the attribute page further includes an existing group label, and in response to selection of an existing group label on the attribute page, the display attribute of the group label of the first question answering pair is determined based on the selected existing group label.

Step a2: the group label of the corresponding first question answering pair is updated in response to the display attribute determined on the attribute page.

Specifically, if the color of the group label changes, the color of the group label of the first question answering pair is updated. If the shape of the group label changes, the shape of the group label of the first question answering pair is updated. If the existence of the group label is cancellation of the group label, the group label of the first question answering pair is cancelled.

It may be understood that the user may customize the color and shape of the group label or cancel the group label by configuring the display attribute of the group label on the attribute page. First question answering pairs with the same group label are divided into one group. If the group label is cancelled, the corresponding first question answering pair is considered as not grouped, indicating that the first question answering pair is invalid content and will not be selected subsequently.

According to the data analysis method based on multi-round question answering provided in this embodiment, the display attribute of the group label of the first question answering pair is configured using the attribute page. Therefore, the group label of the first question answering pair may be flexibly adjusted, and the flexibility of grouping the first question answering pairs is improved.

In some optional implementations, a recommended question of the first question answering pair is displayed in a third sub-area corresponding to each first question answering pair in the dialogue area. The data analysis method based on multi-round question answering according to the present disclosure further includes the following steps.

Step b1: an analysis instruction is generated in response to a selection instruction for the recommended question of any first question answering pair, and the selected recommended question is hided in the corresponding third sub-area, where the analysis instruction is used for analyzing the selected recommended question to obtain answer content of the selected recommended question, to obtain a second question answering pair and a group label of the second question answering pair, and the group label of the second question answering pair is determined based on a semantic analysis result of the second question answering pair.

The third sub-area corresponding to the first question answering pair is a corresponding area of the answer content in the first question answering pair, for example, an area below the answer content in the first question answering pair.

It should be noted that the second question answering pair includes the selected recommended question and the answer content of the selected recommended question.

Specifically, the first language model is used to analyze the selected recommended question to obtain the answer content of the selected recommended question, to obtain the second question answering pair. The first language model is used to perform semantic analysis on the second question answering pair to obtain the semantic analysis result of the second question answering pair. The group label of the second question answering pair is determined based on the semantic analysis result of the second question answering pair.

It should be noted that at the end of a previous round of question answering, the unselected recommended questions do not disappear, and the user may still select the recommended question of a previous question answering pair to continue to ask a question, to obtain a new question answering pair.

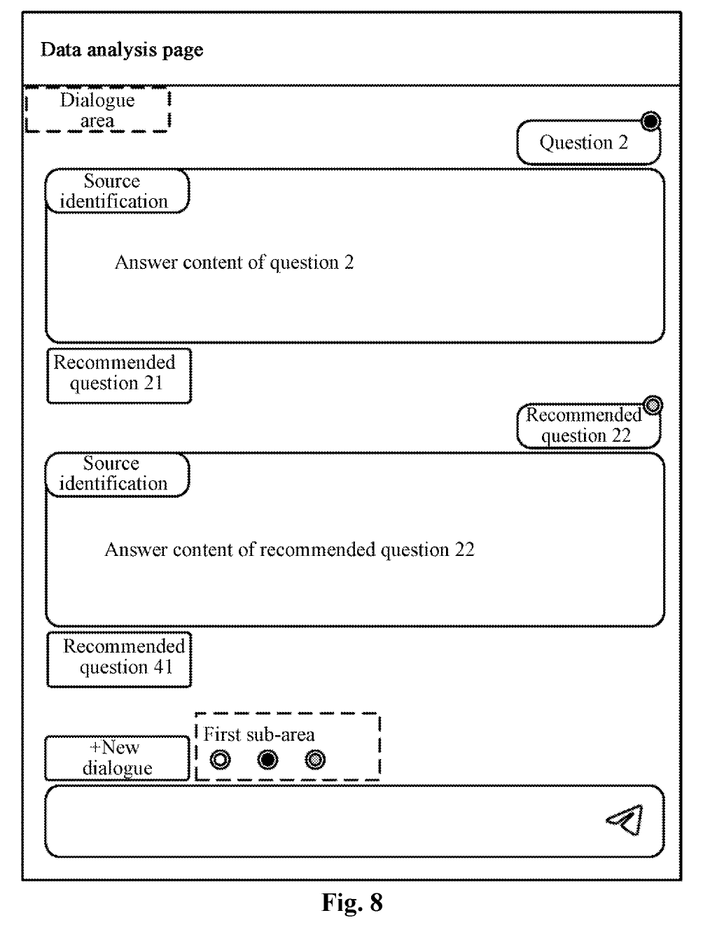

Exemplarily, it is assumed that the first question answering pairs corresponding to question 1 and question 2 are displayed in the dialogue area, the recommended questions of the first question answering pair corresponding to question 1 include recommended question 11 and recommended question 12, and the recommended questions of the first question answering pair corresponding to question 2 include recommended question 21 and recommended question 22. The user may select any one of recommended question 11, recommended question 12, recommended question 21, and recommended question 22 as the next question based on the actual situation. Referring to FIG. 8, it is assumed that recommended question 22 is selected, an analysis instruction of recommended question 22 is generated to obtain the answer content of recommended question 22. recommended question 22 and the answer content of recommended question 22 are displayed in the dialogue area. Meanwhile, recommended question 22 is hidden in the third sub-area corresponding to question 2.

Recommended question 41 is further displayed in the corresponding area of the answer content of recommended question 22, and the user may select recommended question 41 as the question for the next round of question answering to obtain a new question answering pair.

Step b2: the second question answering pair is displayed in the dialogue area, and displaying the group label of the second question answering pair in the first sub-area.

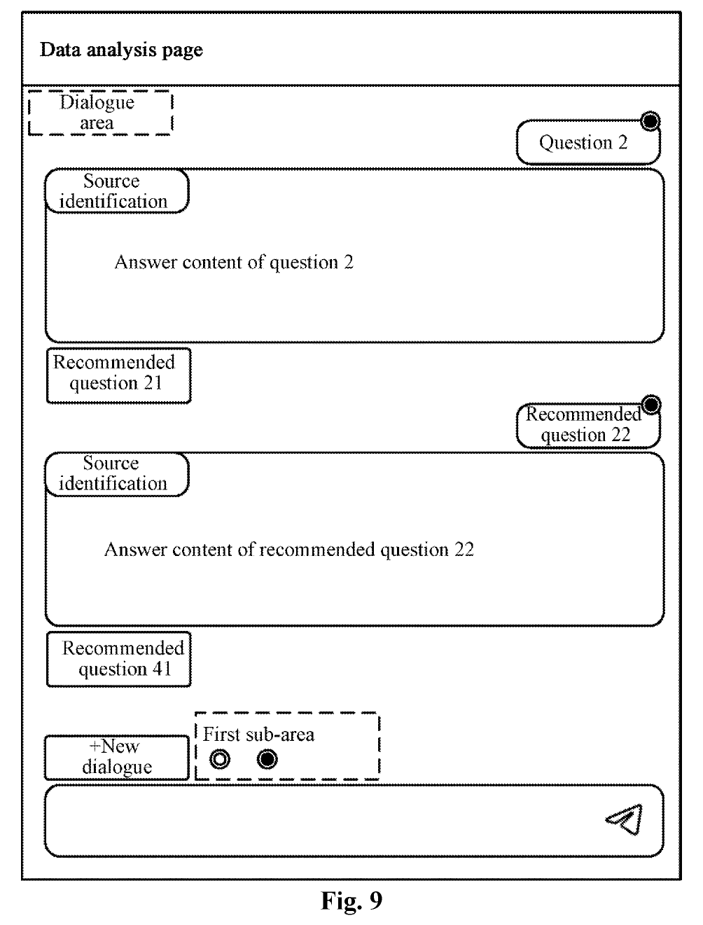

It should be noted that, as shown in FIG. 8, if the first language model determines that the selected recommended question is a drill-down question, a new group label is generated as the group label of the second question answering pair. In this case, the group label of the second question answering pair is displayed in the first sub-area. As shown in FIG. 9, if the group label of the second question answering pair is the same as any group label in the first sub-area, there is no need to repeatedly display the same group label. That is, the group label of the second question answering pair is added to and displayed in the first sub-area only when the group label of the second question answering pair is different from the group labels in the first sub-area. If the group label of the second question answering pair already exists in the first sub-area, there is no need to add the group label of the second question answering pair to the first sub-area again.

According to the data analysis method based on multi-round question answering provided in this embodiment, the recommended question of the first question answering pair is displayed in the third sub-area corresponding to the first question answering pair. Therefore, the recommended question may be used to continue to ask a question, thereby improving the data analysis efficiency. In addition, after the recommended question is selected to continue to ask the question, the selected recommended question is hidden. Therefore, repeated asking of the same question may be avoided, and invalid questions may be reduced.

In some optional implementations, the data analysis method based on multi-round question answering according to the present disclosure further includes: generating an analysis instruction of a target question in response to the target question input in the input control in the dialogue area, where the analysis instruction is used for analyzing the target question to obtain answer content of the target question, to obtain a third question answering pair and a group label of the third question answering pair, and the group label of the third question answering pair is determined based on a semantic analysis result of the third question answering pair; and displaying the third question answering pair in the dialogue area, and displaying the group label of the third question answering pair in the first sub-area.

In some optional implementations, the data analysis method based on multi-round question answering according to the present disclosure further includes: displaying the first question answering pairs and the second question answering pair in the dialogue area according to question answering time in response to a deselection instruction for the first group label.

In actual applications, the first group label in the first sub-area may be selected by clicking, and when the first group label is clicked again, the first group label is deselected, and the deselection instruction for the first group label is generated.

After the first group label is deselected, the question answering pairs in this dialogue are displayed according to the question answering time, to return to a normal dialogue end. The question answering pairs in this dialogue include the first question answering pairs and the second question answering pair.

According to the data analysis method based on multi-round question answering provided in this embodiment, after the first group label is deselected, the question answering pairs are displayed according to the question answering time. Therefore, normal display of the question answering pairs may be ensured.

In some optional implementations, a source identification of the answer content in the question answering pair is displayed in a corresponding area of the first question answering pair and/or the second question answering pair, to facilitate tracing of a source of the answer content.

In some optional implementations, a new dialogue control ("+ new dialogue" in the drawings) is displayed in the dialogue area, and the new dialogue control is used for starting a new dialogue.

In some optional implementations, a drawing board area is further displayed on the data analysis page, and the drawing board area is used for displaying content of interest in the dialogue area and an association relationship between the content of interest.

Optionally, a first data unit corresponding to the question in the 1st first question answering pair is displayed in the drawing board area.

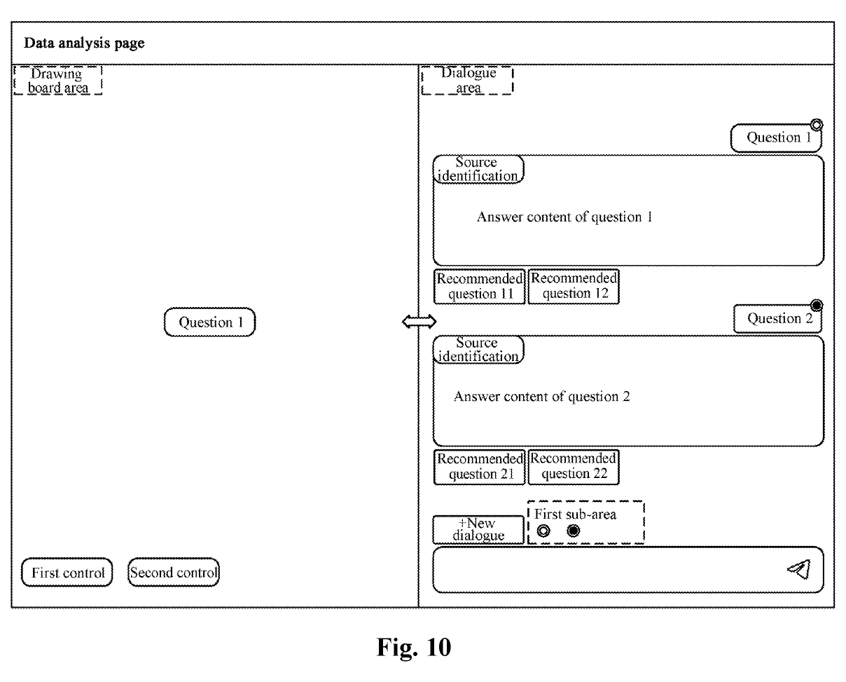

As shown in FIG. 10, it is assumed that the question in the 1st first question answering pair is Question 1. In this case, the first data unit corresponding to Question 1 is displayed in the drawing board area.

Optionally, area sizes of the drawing board area and the dialogue area are adjusted in response to an adjustment instruction for an area size of the drawing board area or the dialogue area.

In actual applications, the drawing board area may be used as a main canvas of the data analysis page, and the dialogue area is embedded in the drawing board area in the form of a panel, to help a user complete the entire process of data analysis on the same data analysis page and avoid cross-use of third-party tools for data analysis.

With reference to the double-headed arrow shown in FIG. 10, the area sizes of the dialogue area and the drawing board area may be adjusted by stretching the panel of the dialogue area.

According to the data analysis method based on multi-round question answering provided in this embodiment, the drawing board area is configured in the data analysis panel to display the content of interest in the dialogue area and the association relationship between the content of interest. Therefore, the content of interest in the dialogue area may be retained in the drawing board area, and the logical relationship between the content of interest may be edited and organized for data analysis. Therefore, there is no need to copy the dialogue content to a document of a third-party tool for analysis, the analysis path is effectively shortened, and cross-use between different data analysis tools is avoided, to meet different data analysis requirements.

In some optional implementations, first analysis content is displayed in the drawing board area, the first analysis content includes at least one first data unit having an association relationship, and the first data unit is generated based on first content of interest in the dialogue area. It should be noted that the first content of interest includes at least one of the question in the 1st first question answering pair or historically selected content of a target question answering pair in the dialogue area. In addition, the first analysis content may further include a data unit corresponding to other content, for example, a data unit of other content, such as a copied picture or text, which is not limited herein.

Further, the data analysis method based on multi-round question answering according to the present disclosure further includes the following steps.

Step c1: second content of interest is determined in response to selected content of the target question answering pair in the dialogue area, where the target question answering pair includes at least one of the first question answering pair or the second question answering pair,

and the second question answering pair is obtained based on the recommended question of the first question answering pair.

Exemplarily, referring to FIG. 11, it is assumed that Question 2 is "Describe the content of Conference A", and the answer content of the question is "Conference A: held from January 1, 2025 to January 10, 2025, and the conference includes a computing power base, application implementation, and other content". If the user selects "Conference A: held from January 1, 2025 to January 10, 2025", this content is used as the second content of interest.

Step c2: a second data unit is displayed at a position corresponding to the second content of interest in the drawing board area in response to an operation of moving the second content of interest to the drawing board area, where the second data unit includes the second content of interest and a unit title, and the unit title is related to the question in the target question answering pair.

Specifically, the second content of interest may be copied and then moved to the drawing board area by dragging, copying, or the like. It should be noted that when the second content of interest is moved to the drawing board area, the selected content in the dialogue area remains unchanged.

Optionally, the unit title is the question in the target question answering pair, or the unit title is obtained through analysis based on the question in the target question answering pair.

Step c3: the second data unit is associated with the first data unit in the drawing board area to obtain second analysis content.

Specifically, the drawing board area corresponds to a second language model, and the second language model may be the same as or different from the first language model. The second language model is used to associate the second data unit with the first data unit based on a distance between the second data unit and the first data unit in the first analysis content. Alternatively, the second language model is used to associate the second data unit with the first data unit based on a correlation between the second data unit and the first data unit in the first analysis content. Alternatively, the second data unit is associated with a corresponding first data unit in response to a connection instruction between the second data unit and any first data unit, to obtain the second analysis content.

Optionally, the first analysis content and the second analysis content are mind maps.

Exemplarily, referring to FIG. 11, the second data unit may be connected to the first data unit corresponding to "question 1" by a connection line, to establish an association relationship between the second data unit and the first data unit, thereby forming the second analysis content.

According to the data analysis method based on multi-round question answering provided in this embodiment, when the second content of interest in the dialogue area is moved to the drawing board area, the second data unit corresponding to the second content of interest is generated in the drawing board area. Therefore, the content in the dialogue area may be further explored using the drawing board area. In addition, the unit title of the second data unit is related to the question in the target question answering pair. Therefore, the source of the second content of interest may be traced using the unit title, the context of the second content of interest may be better understood, and the accuracy of data analysis may be improved.

In some optional implementations, step c3 includes the following steps.

Step c31: a first data unit is determined, in the drawing board area, to be associated with the second data unit based on a distance between the first data unit and the second data unit.

Specifically, a first data unit with a shortest distance is determined, based on distances between the second data unit and the first data units, to be associated with the second data unit.

Step c32: the second data unit is associated with the first data unit determined to be associated, to obtain the second analysis content.

Specifically, a connection line between the second data unit and the first data unit determined to be associated is established to associate the second data unit with the corresponding first data unit, to obtain the second analysis content.

Alternatively, if the second data unit is located within a position range of any first data unit, the first data unit is associated with the second data unit.

According to the data analysis method based on multi-round question answering provided in this embodiment, the association relationship between the second data unit and the first data unit is automatically established based on the distance. Therefore, the efficiency of establishing the association between the second data unit and the first data unit may be improved, thereby improving the data analysis efficiency.

In some optional implementations, the data analysis method based on multi-round question answering according to the present disclosure further includes: updating a target data unit

in response to an edit operation for the target data unit in the drawing board area, where the target data unit is the first data unit or the second data unit.

Specifically, a unit title or content (that is, the content of interest recorded in the target data unit) of the target data unit may be edited, or a connection relationship between the target data unit and another data unit may be edited, to update the target data unit.

In addition, a downstream data unit of the target data unit may also be established based on actual requirements, to obtain new analysis content.

According to the data analysis method based on multi-round question answering provided in this embodiment, the target data unit is editable. Therefore, the target data unit may be flexibly adjusted in the drawing board area based on an analysis idea, to improve the flexibility of data analysis.

In some optional implementations, a collapse control is further displayed on the data analysis page, and the collapse control is used for triggering display or collapse of the dialogue area.

In some optional implementations, the association relationship is a hierarchical attribution relationship, and the first data unit at a top layer is related to the question in the 1st first question answering pair in this dialogue.

Optionally, the first data unit at the top layer includes the question in the 1st first question answering pair, or includes content obtained through analysis based on the question in the 1st first question answering pair.

For example, the first analysis content is a mind map. The first data unit at the top layer is a central node of the first analysis content. After the question of the 1st first question answering pair is determined in the dialogue area/initial page, the first data unit at the top layer is generated in the drawing board area based on the question of the 1st first question answering pair.

According to the data analysis method based on multi-round question answering provided in this embodiment, this dialogue is usually carried out around the first question. Therefore, the first question in this dialogue may usually represent a core topic of this dialogue, and the first data unit at the top layer is generated based on the question. Therefore, the core topic or analysis purpose of this analysis may be represented by the first data unit at the top layer.

In some optional implementations, a first control is further displayed in the drawing board area, and the first control is used for triggering display of historical analysis content and a title of the historical analysis content.

Specifically, in response to an interaction operation for the first control, the historical analysis content and the title of the historical analysis content are displayed in the drawing board area or in a new historical page.

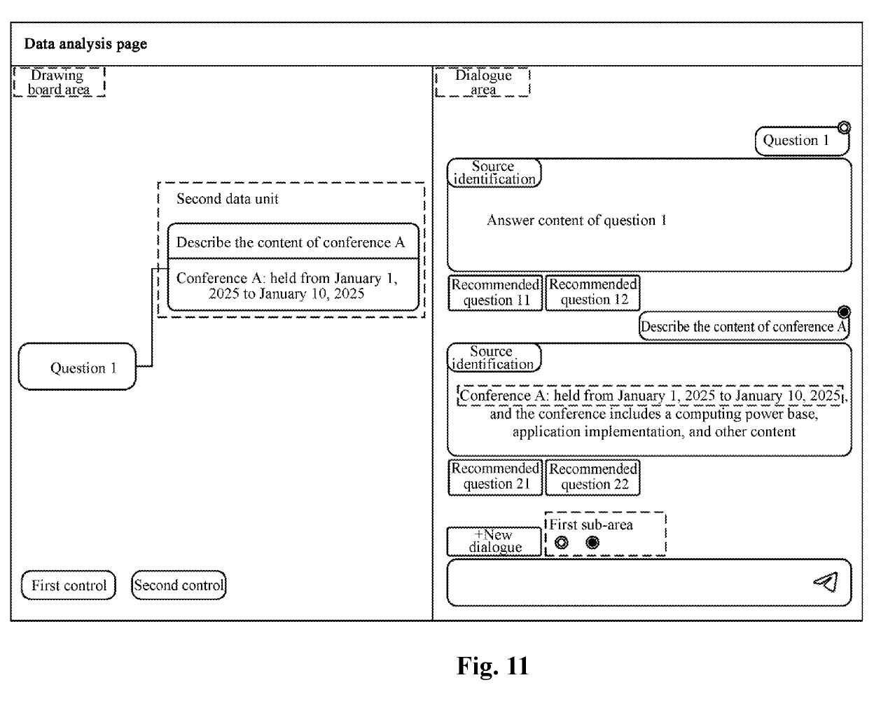

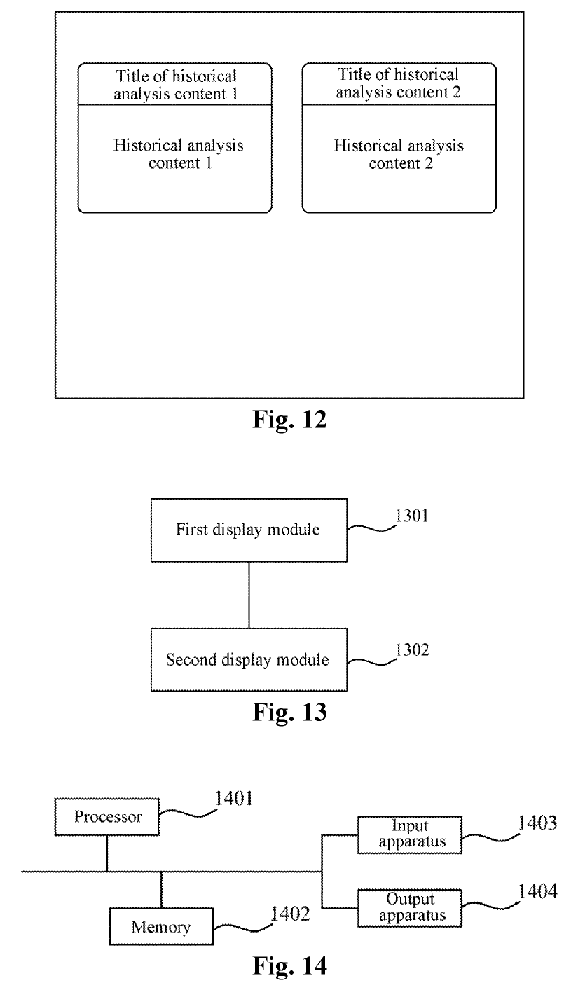

In actual applications, an editable unit may be generated for each piece of historical analysis content and the title thereof, for example, an editable unit composed of historical analysis content 1 and the title thereof and an editable unit composed of historical analysis content 2 and the title thereof shown in FIG. 12. The corresponding historical analysis content may be accessed by interacting with the editable unit.

It should be noted that if there is a large amount of historical analysis content, only some content in the historical analysis content may be displayed.

The title of the historical analysis content is related to the data unit at the top layer in the historical analysis content, or related to the first question in the dialogue corresponding to the historical analysis content, or the title of the historical analysis content is customized by the user.

The historical analysis content includes analysis content historically displayed in the drawing board area.

According to the data analysis method based on multi-round question answering provided in this embodiment, the first control is provided in the drawing board area to trigger the display of the historical analysis content and the title of the historical analysis content. Therefore, the historical analysis content may be quickly queried.

In some optional implementations, while the historical analysis content is displayed, a new creation control may also be displayed, and the new creation control is used for creating new dialogue and/or analysis content.

In some optional implementations, a second control is further displayed in the drawing board area, and the second control is used for exporting content in the drawing board area.

Specifically, the content in the drawing board area, for example, the second analysis content, is exported in response to an interaction operation for the second control. The content in the drawing board area may be exported in a format such as a document or a mind map.

According to the data analysis method based on multi-round question answering provided in this embodiment, the second control is provided in the drawing board area to export the content in the drawing board area. Therefore, data sharing and transfer may be facilitated, to meet diverse data analysis requirements.

As a specific application example, a data analysis application is installed on a computer, and the data analysis application is configured to perform the data analysis method based on multi-round question answering according to the present disclosure. The data analysis page is displayed in the data analysis application, and a user may input a question in the dialogue area of the data analysis page to perform multidimensional exploration in the form of a dialogue, to generate one or more question answering pairs. The group label of each question answering pair is displayed in the first sub-area in the dialogue area. If the user needs to query certain content in a historical dialogue, the user may click the group label corresponding to the content in the first sub-area to filter out irrelevant question answering pairs, and only the question answering pairs under the selected group label are displayed in the dialogue area, to search for the content to be queried. In addition, the user may drag the content of interest in the dialogue area to the drawing board area of the data analysis page, and explore and analyze the content of interest in the drawing board area, for example, edit and organize the logical relationship between different pieces of content of interest, to obtain the analysis content. In addition, the analysis content may also be exported for use in other research and investigation scenarios.

In this embodiment, a data analysis apparatus based on multi-round question answering is further provided. The apparatus is configured to implement the above embodiments and preferred implementations, which are not described herein again. As used below, the term "module" may implement a combination of software and/or hardware for a predetermined function. Although the apparatus described in the following embodiments is preferably implemented in software, implementation in hardware, or a combination of software and hardware is also possible and contemplated.

This embodiment provides a data analysis apparatus based on multi-round question answering. As shown in FIG. 13, the apparatus includes:

a first display module 1301, configured to display a data analysis page, where the data analysis page includes a dialogue area, at least one first question answering pair is displayed in the dialogue area, the first question answering pair has a corresponding group label, a first sub-area of the dialogue area is used for displaying the group label, and the group label is determined based on a semantic analysis result of the first question answering pair; and

a second display module 1302, configured to determine a first group label in response to a selection instruction for the group label in the first sub-area, and display, in the dialogue area, a first question answering pair corresponding to the first group label.

In some optional implementations, the data analysis apparatus of the present disclosure further includes:

a third display module, configured to display the number of question answering pairs corresponding to the group label and description information of the group label, if a current interaction point is located at a position corresponding to any group label in the first sub-area.

In some optional implementations, the group label is displayed in a second sub-area corresponding to each first question answering pair in the dialogue area. The data analysis apparatus of the present disclosure further includes:

a fourth display module, configured to display an attribute page of the group label in response to an interaction operation for the group label in any second sub-area, where the attribute page is used for configuring a display attribute of the group label; and

a label update module, configured to update the group label of the corresponding first question answering pair in response to the display attribute determined in the attribute page.

In some optional implementations, a recommended question of the first question answering pair is displayed in a third sub-area corresponding to each first question answering pair in the dialogue area. The data analysis apparatus of the present disclosure further includes:

a question selection module, configured to generate an analysis instruction in response to a selection instruction for the recommended question of any first question answering pair, and hide the selected recommended question in the corresponding third sub-area, where the analysis instruction is used for analyzing the selected recommended question to obtain answer content of the selected recommended question, to obtain a second question answering pair and a group label of the second question answering pair, and the group label of the second question answering pair is determined based on a semantic analysis result of the second question answering pair; and

a fifth display module, configured to display the second question answering pair in the dialogue area, and display the group label of the second question answering pair in the first sub-area.

In some optional implementations, the data analysis apparatus of the present disclosure further includes:

a sixth display module, configured to display the first question answering pairs and the second question answering pair in the dialogue area according to question answering time, in response to a deselection instruction for the first group label.

In some optional implementations, a drawing board area is further displayed on the data analysis page, and the drawing board area is used for displaying content of interest in the dialogue area and an association relationship between the content of interest.

In some optional implementations, first analysis content is displayed in the drawing board area, the first analysis content includes at least one first data unit having an association relationship, and the first data unit is generated based on first content of interest in the dialogue area. The data analysis apparatus of the present disclosure further includes:

a content selection module, configured to determine second content of interest in response to selected content of a target question answering pair in the dialogue area, where the target question answering pair includes at least one of the first question answering pair or the second question answering pair, and the second question answering pair is obtained based on the recommended question of the first question answering pair;

a content moving module, configured to display a second data unit at a position corresponding to the second content of interest in the drawing board area in response to an operation of moving the second content of interest to the drawing board area, where the second data unit includes the second content of interest and a unit title, and the unit title is related to a question in the target question answering pair; and

a unit association module, configured to associate the second data unit with the first data unit in the drawing board area to obtain second analysis content.

In some optional implementations, the unit association module includes:

an operation unit, configured to determine, in the drawing board area, a first data unit to be associated with the second data unit based on a distance between the first data unit and the second data unit; and

an association unit, configured to associate the second data unit with the first data unit determined to be associated, to obtain the second analysis content.

In some optional implementations, the data analysis apparatus of the present disclosure further includes:

a data edit module, configured to update a target data unit in response to an edit operation for the target data unit in the drawing board area, where the target data unit is the first data unit or the second data unit.

In some optional implementations, the association relationship is a hierarchical attribution relationship, and the first data unit at a top layer is related to the question in the 1st first question answering pair in this dialogue.

In some optional implementations, a first control is further displayed in the drawing board area, and the first control is used for triggering display of historical analysis content and a title of the historical analysis content.

In some optional implementations, a second control is further displayed in the drawing board area, and the second control is used for exporting content in the drawing board area.

Further functional descriptions of the above modules and units are the same as those in the corresponding embodiments above, and are not repeated herein.

The data analysis apparatus based on multi-round question answering in this embodiment is presented in the form of a functional unit. The unit herein refers to an ASIC (Application Specific Integrated Circuit) circuit, a processor and a memory that execute one or more pieces of software or fixed programs, and/or another device that may provide the above functions.

An embodiment of the present disclosure further provides an electronic device having the data analysis apparatus based on multi-round question answering shown in FIG. 13.

Referring to FIG. 14, FIG. 14 is a structural block diagram of an electronic device according to an optional embodiment of the present disclosure. As shown in FIG. 14, the electronic device includes one or more processors 1401, a memory 1402, and interfaces for connecting various components, including high-speed interfaces and low-speed interfaces. The components communicate with each other using different buses, and may be installed on a common mainboard or in other manners as needed. The processor may process instructions executed in the electronic device, including instructions stored in or on the memory to display graphical information of GUI on an external input/output apparatus (for example, a display device coupled to the interface). In some optional implementations, if necessary, a plurality of processors and/or buses may be used with a plurality of memories and a plurality of memories. Similarly, a plurality of electronic devices may be connected, and each device provides some necessary operations (for example, as a server array, a group of blade servers, or a multi-processor system). In FIG. 14, one processor 1401 is used as an example.

The processor 1401 may be a central processing unit or a network processor or a combination thereof. Furthermore, the processor 1401 may further include a hardware chip. The above hardware chip may be an application specific integrated circuit, a programmable logic device, or a combination thereof. The above programmable logic device may be a complex programmable logic device, a field programmable logic gate array, a generic array logic, or any combination thereof.

The memory 1402 stores instructions executable by the at least one processor 1401, so that the at least one processor 1401 executes the method shown in the above embodiments.

The memory 1402 may include a program storage area and a data storage area, where the program storage area may store an application required by an operating system and at least one function; and the data storage area may store data created based on the use of the electronic device, etc. In addition, the memory 1402 may include a high-speed random access memory or a non-transitory memory, such as at least one magnetic disk storage device, a flash memory device, or another non-transitory solid-state storage device. In some optional implementations, the memory 1402 optionally includes memories remotely provided with respect to the processor 1401, and these remote memories may be connected to the electronic device through a network. Examples of the above network include, but are not limited to, Internet, an intranet, a local area network, a mobile communication network, and a combination thereof.

The memory 1402 may include a volatile memory, such as a random access memory; the memory may also include a non-volatile memory, such as a flash memory, a hard disk, or a solid-state disk; and the memory 1402 may further include a combination of the above kinds of memories.

The electronic device further includes an input apparatus 1403 and an output apparatus 1404. The processor 1401, the memory 1402, the input apparatus 1403, and the output apparatus 1404 may be connected through a bus or in other manners. In FIG. 14, connection through a bus is used as an example.

The input apparatus 1403 may receive input digital or character information, and generate a key signal input related to user settings and function control of the electronic device, such as a touch screen, a keypad, a mouse, a track pad, a touch panel, an indicator stick, one or more mouse buttons, a trackball, a joystick, etc. The output apparatus 1404 may include a display device, an auxiliary lighting apparatus (such as an LED), a tactile feedback apparatus (such as a vibration motor), etc. The above display device includes, but is not limited to, a liquid crystal display, a light emitting diode, a display, and a plasma display. In some optional implementations, the display device may be a touch screen.

An embodiment of the present disclosure further provides a computer-readable storage medium. The method according to the embodiment of the present disclosure may be implemented in hardware or firmware, or implemented as computer code that may be recorded in a storage medium or originally stored in a remote storage medium or a non-transitory machine-readable storage medium and downloaded through a network and will be stored in a local storage medium. Therefore, the method described herein may be stored in such software processing on a storage medium using a general-purpose computer, a dedicated processor, or programmable or dedicated hardware. The storage medium may be a magnetic disk, an optical disk, a read-only memory, a random access memory, a flash memory, a hard disk, or a solid-state disk, and further, the storage medium may also include a combination of the above kinds of memories. It may be understood that the computer, the processor, the microprocessor controller, or the programmable hardware includes a storage component that may store or receive software or computer code, and when the software or computer code is accessed and executed by the computer, the processor, or the hardware, the method shown in the above embodiments is implemented.

A part of the present disclosure may be applied as a computer program product, such as computer program instructions that, when executed by a computer, may invoke or provide the method and/or technical solution according to the present disclosure through the operation of the computer. A person skilled in the art should understand that the computer program instructions exist in a computer-readable medium in a form including but not limited to a source file, an executable file, an installation package file, etc. Correspondingly, the computer program instructions are executed by the computer in a manner including but not limited to: the computer directly executes the instructions, or the computer compiles the instructions and then executes a corresponding compiled program, or the computer reads and executes the instructions, or the computer reads and installs the instructions and then executes a corresponding installed program. Here, the computer-readable medium may be any available computer-readable storage medium or communication medium accessible by the computer.

Although the embodiments of the present disclosure are described with reference to the drawings, a person skilled in the art may make various modifications and variations without departing from the spirit and scope of the present disclosure, and such modifications and variations fall within the scope defined by the appended claims.

We claim:

1. A data analysis method based on multi-round question answering, comprising:
displaying a data analysis page, the data analysis page comprising a dialogue area, at least one first question answering pair being displayed in the dialogue area, the first question answering pair having a corresponding group label, a first sub-area of the dialogue area being used for displaying the group label, and the group label being determined based on a semantic analysis result of the first question answering pair; and
determining, in response to a selection instruction for the group label in the first sub-area, a first group label, and displaying, in the dialogue area, a first question answering pair corresponding to the first group label.

2. The data analysis method of claim 1, wherein the method further comprises:
in response to a current interaction point being located at a position corresponding to any group label in the first sub-area, displaying a number of question answering pairs corresponding to the group label and description information of the group label.

3. The data analysis method of claim 1, wherein the group label is displayed in a second sub-area corresponding to first question answering pairs in the dialogue area; and the method further comprises:
displaying an attribute page of the group label in response to an interaction operation for the group label in any of second sub-areas, the attribute page being used for configuring a display attribute of the group label; and
updating the group label of the corresponding first question answering pair in response to the display attribute determined in the attribute page.

4. The data analysis method of claim 1, wherein a recommended question of the first question answering pair is displayed in a third sub-area corresponding to the first question answering pairs in the dialogue area, and the method further comprises:
generating an analysis instruction in response to a selection instruction for the recommended question of any of the first question answering pairs, and hiding a selected recommended question in the corresponding third sub-area, the analysis instruction being used for analyzing the selected recommended question to obtain answer content of the selected recommended question, to obtain a second question answering pair and a group label of the second question answering pair, and the group label of the second question answering pair being determined based on a semantic analysis result of the second question answering pair; and
displaying the second question answering pair in the dialogue area, and displaying the group label of the second question answering pair in the first sub-area.

5. The data analysis method of claim 4, wherein the method further comprises:
displaying, in response to a deselection instruction for the first group label, the first question answering pairs and the second question answering pair in the dialogue area according to question answering time.

6. The data analysis method of claim 1, wherein a drawing board area is further displayed on the data analysis page, and the drawing board area is used for displaying content of interest in the dialogue area and an association relationship between the content of interest.

7. The data analysis method of claim 6, wherein first analysis content is displayed in the drawing board area, the first analysis content comprises at least one first data unit having an association relationship, and the first data unit is generated based on first content of interest in the dialogue area, and the method further comprises:
determining second content of interest in response to selected content of a target question answering pair in the dialogue area, the target question answering pair comprising at least one of the first question answering pairs or a second question answering pair, and the second question answering pair being obtained based on a recommended question of the first question answering pairs;
displaying, in response to an operation of moving the second content of interest to the drawing board area, a second data unit at a position corresponding to the second content of interest in the drawing board area, the second data unit comprising the second content of interest and a unit title, and the unit title being related to a question in the target question answering pair; and
associating the second data unit with the first data unit in the drawing board area to obtain second analysis content.

8. The data analysis method of claim 7, wherein associating the second data unit with the first data unit in the drawing board area to obtain the second analysis content comprises:
determining, in the drawing board area, the first data unit to be associated with the second data unit based on a distance between the first data unit and the second data unit; and
associating the second data unit with the first data unit determined to be associated, to obtain the second analysis content.

9. The data analysis method of claim 7, wherein the method further comprises:
updating a target data unit in response to an edit operation for the target data unit in the drawing board area, the target data unit being the first data unit or the second data unit.

10. The data analysis method of claim 7, wherein the association relationship is a hierarchical attribution relationship, and the first data unit at a top layer is related to the question in the 1st first question answering pair in this dialogue.

11. The data analysis method of claim 6, wherein a first control is further displayed in the drawing board area, and the first control is used for triggering display of historical analysis content and a title of the historical analysis content.

12. The data analysis method of claim 6, wherein a second control is further displayed in the drawing board area, and the second control is used for exporting content in the drawing board area.

13. An electronic device, comprising:
one or more processors;
a storage device for storing one or more programs, wherein,
the one or more programs, when executed by the one or more processors, cause the one or more processors to:
display a data analysis page, the data analysis page comprising a dialogue area, at least one first question answering pair being displayed in the dialogue area, the first question answering pair having a corresponding group label, a first sub-area of the dialogue area being used for displaying the group label, and the group label being determined based on a semantic analysis result of the first question answering pair; and
determine, in response to a selection instruction for the group label in the first sub-area, a first group label, and display, in the dialogue area, a first question answering pair corresponding to the first group label.

14. The device of claim 13, the one or more programs further causing the one or more processors to:
in response to a current interaction point being located at a position corresponding to any group label in the first sub-area, display a number of question answering pairs corresponding to the group label and description information of the group label.

15. The device of claim 13, wherein the group label is displayed in a second sub-area corresponding to first question answering pairs in the dialogue area; and the one or more programs further cause the one or more processors to:
display an attribute page of the group label in response to an interaction operation for the group label in any of second sub-areas, the attribute page being used for configuring a display attribute of the group label; and
update the group label of the corresponding first question answering pair in response to the display attribute determined in the attribute page.

16. The device of claim 13, wherein a recommended question of the first question answering pair is displayed in a third sub-area corresponding to the first question answering pairs in the dialogue area, and the one or more programs further cause the one or more processors to:
generate an analysis instruction in response to a selection instruction for the recommended question of any of the first question answering pairs, and hide a selected recommended question in the corresponding third sub-area, the analysis instruction being used for analyzing the selected recommended question to obtain answer content of the selected recommended question, to obtain a second question answering pair and a group label of the second question answering pair, and the group label of the second question answering pair being determined based on a semantic analysis result of the second question answering pair; and
display the second question answering pair in the dialogue area, and display the group label of the second question answering pair in the first sub-area.

17. The device of claim 16, the one or more programs further causing the one or more processors to:
display, in response to a deselection instruction for the first group label, the first question answering pairs and the second question answering pair in the dialogue area according to question answering time.

18. The device of claim 13, wherein a drawing board area is further displayed on the data analysis page, and the drawing board area is used for displaying content of interest in the dialogue area and an association relationship between the content of interest.

19. The device of claim 18, wherein first analysis content is displayed in the drawing board area, the first analysis content comprises at least one first data unit having an association relationship, and the first data unit is generated based on first content of interest in the dialogue area, and the one or more programs further cause the one or more processors to:
determine second content of interest in response to selected content of a target question answering pair in the dialogue area, the target question answering pair comprising at least one of the first question answering pairs or a second question answering pair, and the second question answering pair being obtained based on a recommended question of the first question answering pairs;
display, in response to an operation of moving the second content of interest to the drawing board area, a second data unit at a position corresponding to the second content of interest in the drawing board area, the second data unit comprising the second content of interest and a unit title, and the unit title being related to a question in the target question answering pair; and
associate the second data unit with the first data unit in the drawing board area to obtain second analysis content,
wherein associating the second data unit with the first data unit in the drawing board area to obtain the second analysis content comprises:
determining, in the drawing board area, the first data unit to be associated with the second data unit based on a distance between the first data unit and the second data unit; and
associating the second data unit with the first data unit determined to be associated, to obtain the second analysis content,
wherein the one or more programs further cause the one or more processors to:
update a target data unit in response to an edit operation for the target data unit in the drawing board area, the target data unit being the first data unit or the second data unit,
wherein the association relationship is a hierarchical attribution relationship, and the first data unit at a top layer is related to the question in the 1st first question answering pair in this dialogue,
wherein a first control is further displayed in the drawing board area, and the first control is used for triggering display of historical analysis content and a title of the historical analysis content, and
wherein a second control is further displayed in the drawing board area, and the second control is used for exporting content in the drawing board area.

20. A non-transitory storage medium containing computer-executable instructions, wherein the computer-executable instructions, when executed by one or more computer processors, are used to cause the one or more computer processors to:
display a data analysis page, the data analysis page comprising a dialogue area, at least one first question answering pair being displayed in the dialogue area, the first question answering pair having a corresponding group label, a first sub-area of the dialogue area being used for displaying the group label, and the group label being determined based on a semantic analysis result of the first question answering pair; and
determine, in response to a selection instruction for the group label in the first sub-area, a first group label, and displaying, in the dialogue area, a first question answering pair corresponding to the first group label.
